(19) United States
(12) Patent Application Publication
(10) Pub. No.: US 2026/0215370 A1
(43) Pub. Date: Jul. 30, 2026

(54) Double Baler Having Bale Chamber Center Flow Restrictors

(71) Applicant: AGCO Corporation, Duluth, GA (US)

(72) Inventors: Kelly B. Booton, Lehigh, KS (US); Tracy Alan Jahay, Hesston, KS (US); Colton Aaron, Hesston, KS (US)

(21) Appl. No.: 19/451,404

(22) Filed: Jan. 16, 2026

Related U.S. Application Data
(60) Provisional application No. 63/750,953, filed on Jan. 29, 2025.

(51) Int. Cl. A01F 15/04

(52) U.S. Cl. CPC A01F 15/046

(57) ABSTRACT

A baler compresses plant material in a baling chamber with a reciprocating plunger. The baler includes a stationary knife mounted in the baling chamber extending vertically between a floor and a roof, and a dividing partition extending rearward from the knife and intermediate the side walls of the baling chamber such that plant material moved into the baling chamber is split by movement of the plunger relative to the knife and pushed into first and second bale-forming compartments to form a first bale in the first bale-forming compartment on one side of the dividing partition and a second bale in the second bale-forming compartment on an opposite side of the dividing partition, where each side of the dividing partition has a flow resisting mechanism configured to resist rearward movement of the bale being formed in the respective first and second bale-forming compartments.

### CROSS REFERENCE TO RELATED APPLICATIONS

This application claims the benefit of the filing date of U. S. Provisional Patent Application 63/750,953, “Double Baler Having Bale Chamber Center Flow Restrictors,” filed January 29, 2025, the entire disclosure of which is incorporated herein by reference.

### BACKGROUND

### Field

This disclosure relates to agricultural harvesting machines such as balers and, more particularly, to a baler that concurrently forms multiple bales of crop material.

### Description of Related Art

Picking up and baling of material in a field is an internal aspect of farming and is an expensive and labor-intensive process. The material normally is forage such for example, hay, biomass, alfalfa, straw, coastal Bermuda, and corn stalks and is referred to herein as crop material. Typically, crop material picked-up by machinery and fed to a baling chamber where the crop material is compressed and tied to form bales. Conventional square hay balers include a bale forming chamber and a reciprocating plunger that slides into and out of the chamber. “Square” bales are often preferred in that the square-shouldered bales facilitate stacking, delivery and use and, as used herein, square bales means bales having square shoulders. As the chamber receives loose hay material, the plunger slides into the chamber during a compaction stroke to compress the loose hay material into the form of a bale. Such balers typically include a drive train that transmits power to the reciprocating plunger.

Attempts to improve baling efficiency have included the production larger balers that produce very large, high-density bales. These large square bales are heavy and impossible to move by hand, making them undesirable for the small hobby farmer. Attempts have been made to use larger balers to produce bales of a reduced size in pairs such as by U.S. Pat. No. 3,099,203 to Klemm et al. It would be desirable to have an improved baler that concurrently forms multiple bales.

### BRIEF SUMMARY

In one aspect, an agricultural baler has a pickup assembly configured to take cut plant material from the ground and move the plant material to a baling chamber and compress the plant material in the baling chamber with a reciprocating plunger. The baling chamber is formed with a floor, a roof and opposing side walls. The baler includes a stationary knife mounted in the baling chamber extending vertically between the floor and the roof, and a dividing partition extending rearward from the knife, where the dividing partition extends from the roof to the floor of the baling chamber and is intermediate the side walls of the baling chamber such that plant material moved into the baling chamber is split by movement of the plunger relative to the knife and pushed into first and second bale-forming compartments to form a first bale in the first bale-forming compartment on one side of the dividing partition and a second bale in the second bale-forming compartment on an opposite side of the dividing partition. Each side of the dividing partition has a flow resisting mechanism configured to resist rearward movement of the bale being formed in the respective first and second bale-forming compartments.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a side elevation view of an example baler machine configured to receive loose plant material and shape and secure the material into a bale;

FIG. 2 is a perspective view of a baling chamber of the baler of FIG. 1;

FIG. 3 is a cutaway perspective view of a portion of the baling chamber of FIG. 2; and

FIG. 4 illustrates is cutaway side view of the baling chamber of FIG. 3.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms "left" or "right" are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already be widely known or used by persons skilled in the art and each will likewise not therefore be discussed in significant detail.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present invention can include a variety of combinations and/or integrations of the embodiments described herein.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

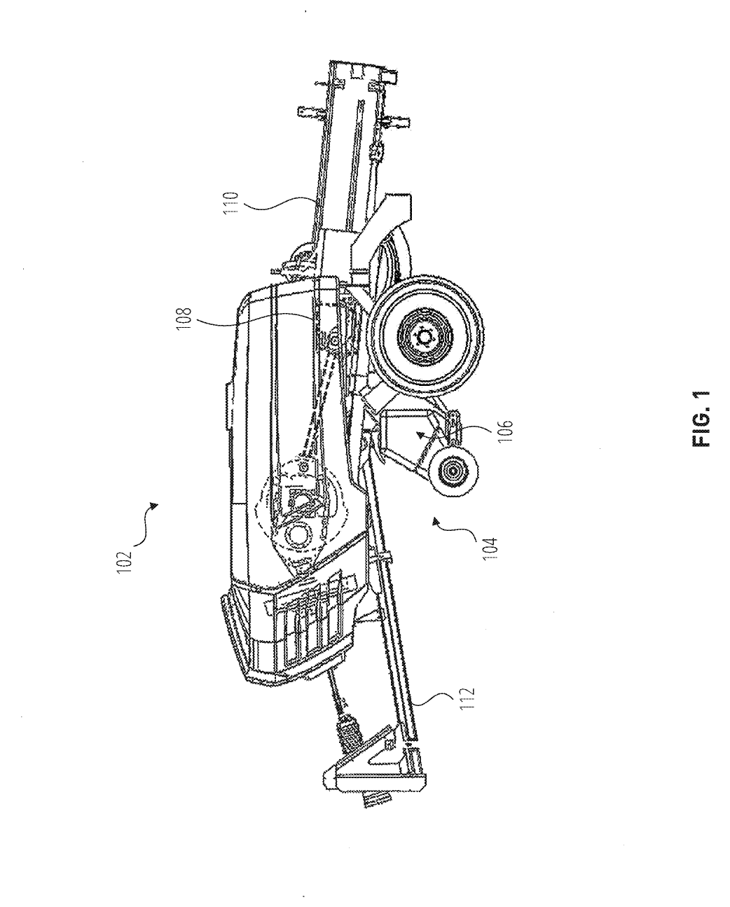

Referring to FIG. 1, an example agricultural baler 102 is shown into which embodiments of the present invention may be incorporated. Although the example baler 102 is a towed square baler, it will be appreciated that embodiments of the present invention may be incorporated into other types of balers (e.g., self-propelled) with few or no changes. Broadly, the baler 102 may be configured to move over a field and collect previously cut plant material and to compress, shape, and secure the collected plant material into a plurality of bales. The baler 102 may generally include a pickup assembly 104, a stuffer chute assembly 106, a reciprocating plunger 108, and a baling (or compression) chamber 110. Additionally, the baler 102 may be hitched to a towing vehicle (not shown) by a tongue 112, and power for operating the various mechanisms (e.g., the reciprocating plunger 108) of the baler 102 may be supplied by a power take-off of the towing vehicle.

The pickup assembly 104 may be configured to collect the cut plant material from the field. In one implementation, the baler 102 may include a pair of ground wheels 114 that support the pickup assembly 104 as the baler 102 moves over the field. The stuffer chute assembly 106 may be configured to direct the collected plant material into position to be moved into the baling chamber 110. In one implementation, the stuffer chute assembly 106 may include a charge-forming duct 116 extending from an inlet opening adjacent to the pickup assembly 104 to an outlet opening into the baling chamber 110. The crop material is moved from charge-forming duct 116 into the baling chamber 110 where the reciprocating plunger 108 may be configured to compress the plant into a growing bale. In one implementation, the plunger 108 may be configured to reciprocate within the baling chamber 110 in repeating compression and retraction strokes across the outlet opening of the charge-forming duct 116. As the plunger 108 retracts, the outlet opening is uncovered and an additional flake, charge, or other subunit of plant material enters the baling chamber 110, and as the plunger 108 contracts the outlet opening is covered and the additional subunit of plant material is compressed into the growing bale.

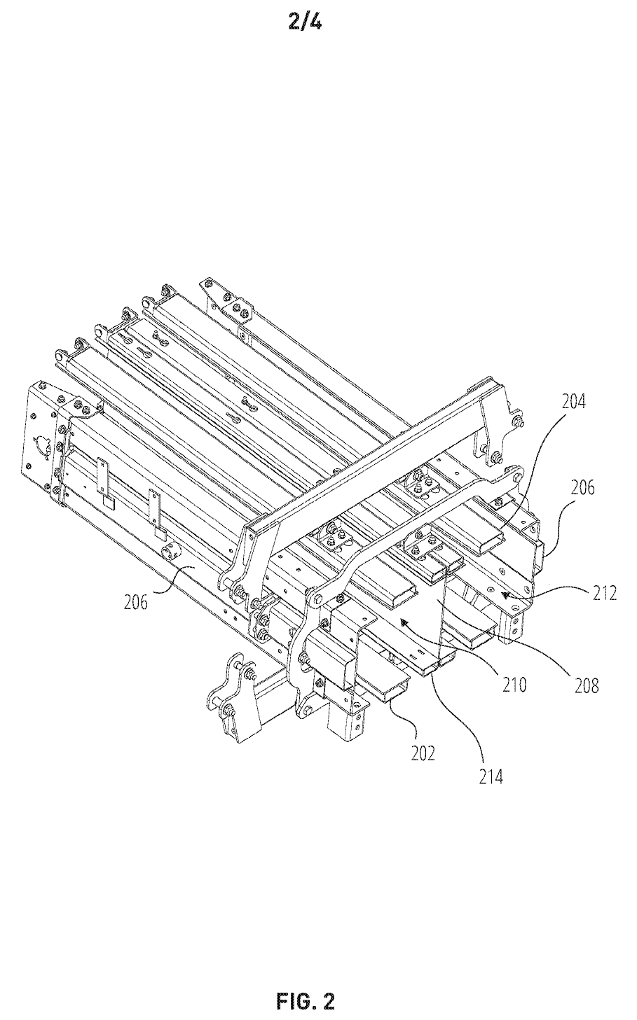

Turning now to FIG. 2, the baling chamber 110 is formed with a floor 202, a roof 204 and opposing side walls 206. The reciprocating plunger 108 may be configured to compress the plant material from the charge-forming duct 116 into the space between the floor 202, the roof 204 and the side walls 206 of the baling chamber 110. A dividing partition 208 splits the baling chamber 110 into a left bale forming compartment 210 and a right bale forming compartment 212. The dividing partition 208 is generally in a plane parallel with the side walls 206 of the baling chamber 110. Desirably, the dividing partition 208 has a length that extends to a discharge end of the baling chamber 110. The dividing partition 208 is secured in the baling chamber 110 with suitable mounting means in the roof 204 and the floor 202 using sound engineering judgment.

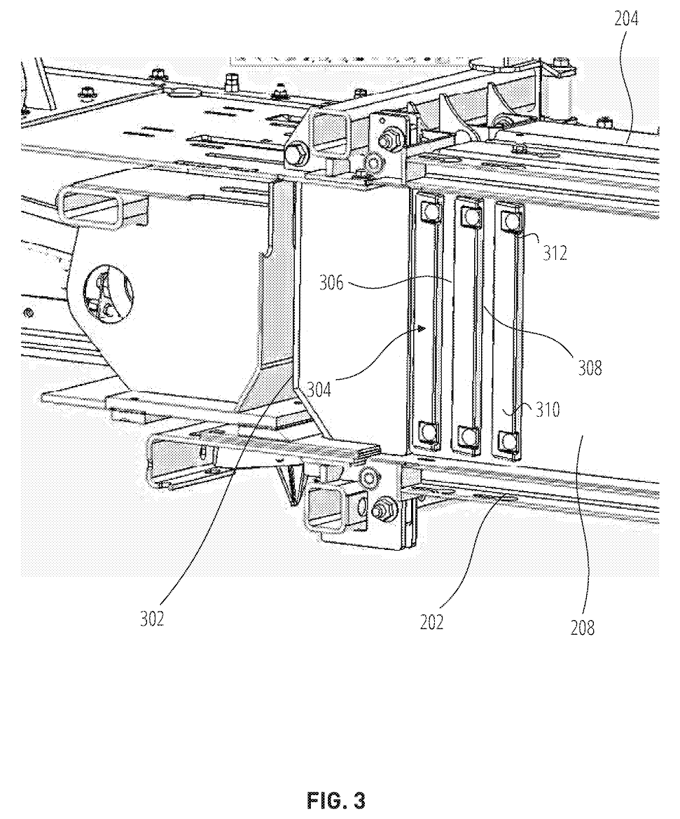

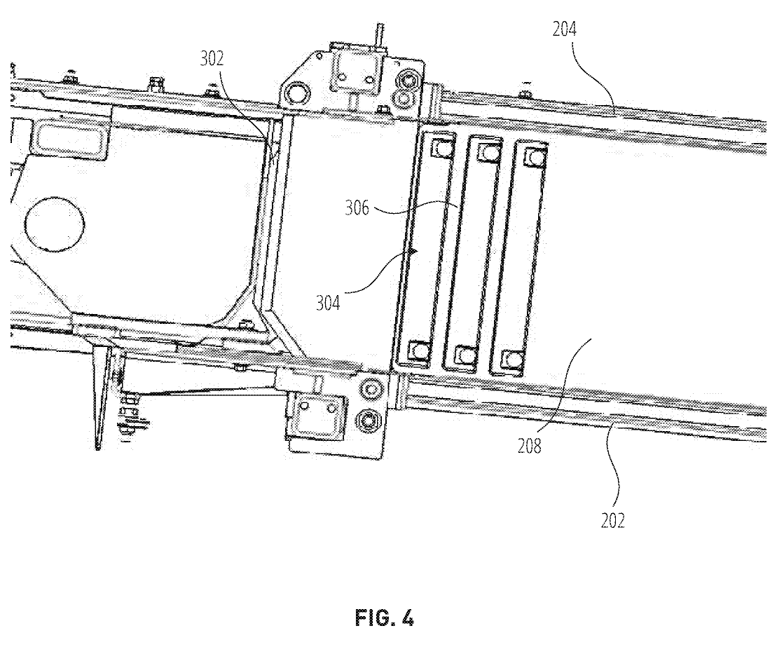

FIGS. 3 and 4 illustrate views of the baling chamber 110 with the left side removed for clarity. The plunger 108 is moved rearward to compress the plant material received in the baling chamber 110 from the stuffer chute assembly 106 such that the plunger 108 pushes the crop material against and past a stationary splitting knife 302 which extends substantially vertically in the baling chamber 110 between the floor 202 and the roof 204 in a plane parallel with the side walls 206. The dividing partition 208 extends rearward from the splitting knife 302. The plunger 108 comes close to contacting the knife 302 but, preferably, does not contact the knife 302. The plunger 108 mashes the flakes of crop material against the edge of the splitting knife 302 to split each flake as it enters the bale forming portion of the baling chamber 110. The compressed crop material split by movement of the plunger 108 relative to the knife 302 is pushed into the separate left and right bale-forming compartments 210, 212 to concurrently form first and second bales, with the first bale formed in the left bale forming compartment 210 on one side of the dividing partition 208 and the second bale formed in the right bale forming compartment 212 on the other side of the dividing partition 208.

Each side of the dividing partition 208 has a flow resisting mechanism 304 configured to resist rearward movement of the bale being formed in the respective left and right bale forming compartment 210, 212 as the plunger 108 pushes the forming bales rearward as newly added plant material is added. In one embodiment, the flow resisting mechanism 304 comprises at least one elongated restrictor 306 positioned generally vertical and affixed to the dividing partition 208 such that the restrictor 306 extends away from the surface of the dividing partition 208 and into the bale-forming compartment 210, 212. In the illustrated embodiment, the restrictor 306 extends generally vertically from near the floor 202 to near the roof 204 of the baling chamber 110. In the illustrated embodiment, the dividing partition 208 has three elongated and generally parallel restrictors 306 mounted on each side of the dividing partition 208, with each restrictor 306 separated by a gap 308 from the adjacent restrictor 306. However, one skilled in the art will understand that the flow resisting mechanism 304 may made up of more or fewer numbers of individual restrictors 306.

Each restrictor 306 may have a body 310 formed of a plate with constant thickness, or may have a wedge or other shape. In the illustrated embodiment, each restrictor 306 has the body 310 formed as a single continuous member. However, each restrictor 306 can be made of segmented bodies 310 that together cover a majority of the distance between the floor 202 and the roof 204 of the baling chamber 110. In the illustrated embodiment the restrictors 306 are mounted flush against the surface of the dividing partition 208 and have a substantially uniform shape. However, one skilled in the art will understand that each restrictor 306 may be shaped to have a number of protrusions or so as to form one or more gaps between the restrictor 306 and the surface of the dividing partition 208. Desirably, each restrictor 306 extends between 0.25 and 3.0 inches away from the surface of the dividing partition 208 into the bale-forming compartment 210, 212. In one embodiment, the flow resisting mechanism 304 covers less than half of a length of the dividing partition 208 between the knife 302 and the discharge end 214. In one embodiment, the flow resisting mechanism 304 is positioned in a front portion of the baling chamber 110 near the knife 302 so that the restrictors 306 have the greatest influence on evening out and shaping the most newly formed flakes in the growing bales. The flow resisting mechanism 304 can be bolted, riveted, welded, or otherwise mounted to the dividing partition 208 with suitable fasteners 312 using sound engineering judgment.

As is known in the art, the floor 202, roof 204, and side walls 206 of the baling chamber 110 may form a tension chamber controlled by hydraulic cylinders with the use of a computer to create the desired weight in each bale. The tension chamber squeezes the top, bottom and both sides of the bales to achieve the desired weight and size of each bale. The bales are tied by a suitable knotter mechanism (not shown) as would be understood by one skilled in the art. The baling chamber 110 may be configured to shape the growing bale and secure the compressed plant material in the individual bale. Control of the size and weight of the two bales formed in the first and second portions of the baling chamber 110 is achieved by suitable which sense the parameters of each of the bales and provide an indication of any need to vary the flow of crop material to the baling chamber. The finished bale may be ejected rearwardly to land on the field behind the baler for subsequent collection.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. An agricultural baler having a pickup assembly configured to take cut plant material from the ground and move the plant material to a baling chamber and compress the plant material in the baling chamber with a reciprocating plunger, the baling chamber being formed with a floor, a roof and opposing side walls, the baler comprising:
a stationary knife mounted in the baling chamber extending vertically between the floor and the roof; and
a dividing partition extending rearward from the knife, wherein the dividing partition extends from the roof to the floor of the baling chamber and is intermediate the side walls of the baling chamber such that plant material moved into the baling chamber is split by movement of the plunger relative to the knife and pushed into first and second bale-forming compartments to form a first bale in the first bale-forming compartment on one side of the dividing partition and a second bale in the second bale-forming compartment on an opposite side of the dividing partition, wherein each side of the dividing partition has a flow resisting mechanism configured to resist rearward movement of the bale being formed in the respective first and second bale-forming compartments.

2. The baler of claim 1 wherein the flow resisting mechanism comprises at least one elongated restrictor on each side of the dividing partition such that the restrictor extends away from a surface of the dividing partition and into its respective bale-forming compartment.

3. The baler of claim 1 wherein the restrictor extends vertically from near the floor to near the roof of the baling chamber.

4. The baler of claim 2 wherein the dividing partition has three elongated and generally parallel restrictors mounted on each side of the dividing partition, with each restrictor separated by a gap from its adjacent restrictor.

5. The baler of claim 2 wherein each restrictor has a body formed as a single continuous member.

6. The baler of claim 2 wherein the flow resisting mechanism covers less than half of a length of the dividing partition between the knife and a discharge end of the baling chamber.

7. The baler of claim 2 the flow resisting mechanism is positioned in a front portion of the baling chamber near the knife.

8. The baler of claim 1 wherein the dividing partition is in a plane parallel with the side walls of the baling chamber.

9. The baler of claim 1 wherein the dividing partition extends from the knife rearward to a discharge end of the baling chamber.
